(19) United States
(12) Patent Application Publication
(10) Pub. No.: US 2026/0005633 A1
(43) Pub. Date: Jan. 1, 2026

(54) CONTROLLING A MOTOR BASED ON A FLOW RATE OF HYDRAULIC FLUID TO THE MOTOR

(71) Applicant: Robert Bosch GmbH, Stuttgart (DE)

(72) Inventors: Frank Kachinski, Fountain Inn, SC (US); Rafael Cardoso, Fountain Inn, SC (US); Enrique Busquets, Fountain Inn, SC (US)

(21) Appl. No.: 18/756,572

(22) Filed: Jun. 27, 2024

(51) Int. Cl. H02P 23/14; F15B 19/00; F15B 21/00

(52) U.S. Cl. CPC H02P 23/14; F15B 19/00; F15B 21/00; F15B 2211/63

(57) ABSTRACT

A system for controlling a motor based on a flow rate of hydraulic fluid to the motor. The system includes an electronic processor. The electronic processor is configured to determine a current speed of the motor and, when the current speed is less than a target speed, determine whether the motor is loaded or unloaded. The electronic processor is also configured to, when the motor is loaded, determine a first displacement based on a relationship between displacement of the motor and speed of the motor and set the displacement of the motor to the first displacement. The first displacement is less than a displacement associated with the current speed. The electronic processor is further configured to, when the motor is unloaded, determine a second displacement based on the relationship and set the displacement of the motor to a second displacement less than or equal to the first displacement.

### SUMMARY

There are many tools that can be attached to vehicles or carriers (for example, tractors, skid steers, backhoes, or the like) to perform a task. For example, an attachment tool or implement with a rotating drum and a hydraulic motor may be attached to a carrier and connected to the hydraulic system of the carrier. The hydraulic system of the carrier provides hydraulic flow to the attachment tool. In turn, the attachment tool performs a task (for example, a mulching or cutting task). However, a flow rate of hydraulic fluid from the carrier to the attachment tool may vary from carrier to carrier. The relationship between speed of a motor in the attachment tool and displacement of the motor in the attachment tool is influenced by the flow rate of the hydraulic fluid. Therefore, when the attachment tool is attached to a first carrier with a higher flow rate than a second carrier and has a motor set to a first displacement, the motor will run at a faster speed than the motor would when the attachment tool is attached to the second carrier and has the motor set to the same first displacement. In some implementations, the motor is a variable hydraulic motor. The displacement of a variable hydraulic motor may refer to a volume of fluid displaced per revolution of the motor shaft, which may be achieved through one of a plurality of different mechanisms. These mechanisms may include, but are not limited to, the movement of pistons within a cylinder block, the rotation of a vane within a chamber, or the flexing of a bent axis mechanism. The displacement of a variable hydraulic motor may be varied by adjusting a stroke length of pistons, an angle of a swash plate, a position of a control ring, or the like, depending on the design of the variable hydraulic motor.

Currently, many attachment tools require a human operator to manually calibrate the attachment tool to based on the flow rate of hydraulic fluid from the carrier. The implementations described herein provide, among other things, an attachment tool that automatically calibrates based on a flow rate of the hydraulic fluid from a carrier to the attachment tool by determining a relationship between displacement of a motor and speed of the motor when the attachment tool is powered on. Additionally, some implementations described herein provide systems and methods for continuously attempting to increase the speed of the motor in the attachment tool when the speed of the motor is less than a target speed, regardless of whether the motor is loaded or unloaded. Generally, a motor is loaded when the motor performs a task (for example, cutting, chopping, mulching, or the like). When a motor is loaded it often decelerates. The systems and methods described herein consider, among other things, whether the motor is loaded or unloaded when attempting to increase the speed of the motor.

Thus, the systems and methods described herein provide, among other things, an attachment tool which has a motor that is not easily stalled and is quick to recover speed without requiring a human operator to calibrate the attachment tool.

U.S. Patent No. 11,889,790 teaches “a hydraulically powered implement for use in connection with a tractor that has a hydraulic pump that supplies pressurized hydraulic fluid to the implement.” U.S. Patent No. 11,889,790 also teaches that “[i]n response to measurements made by the speed sensor 120, the controller 110 shifts the motor between speed-dependent shift points by adjusting the volume of the variable displacement motor 116.” However, U.S. Patent No. 11,889,790 fails to teach a method for determining a relationship between displacement of a motor and speed of the motor as described herein. U.S. Patent No. 11,889,790 also fails to teach a method for controlling a motor based on a flow rate of hydraulic fluid to the motor described herein.

One example implementation provides a system for controlling a motor based on a flow rate of hydraulic fluid to the motor. The system includes an electronic processor. The electronic processor is configured to determine a current speed of the motor and, when the current speed is less than a target speed, determine whether the motor is loaded or unloaded. The electronic processor is also configured to, when the motor is loaded, determine a first displacement based on a relationship between displacement of the motor and speed of the motor and set the displacement of the motor to the first displacement. The first displacement is less than a displacement associated with the current speed of the motor. The electronic processor is further configured to, when the motor is unloaded, determine a second displacement based on the relationship and set the displacement of the motor to a second displacement. The second displacement is less than or equal to the first displacement.

Another example implementation provides a method for controlling a motor based on a flow rate of hydraulic fluid to the motor. The method includes determining a current speed of the motor and, when the current speed is less than a target speed, determining whether the motor is loaded or unloaded. The method also includes, when the motor is loaded, determining a first displacement based on a relationship between displacement of the motor and speed of the motor and setting the displacement of the motor to the first displacement. The first displacement is less than a displacement associated with the current speed of the motor. The method further includes, when the motor is unloaded, determining a second displacement based on the relationship and setting the displacement of the motor to a second displacement. The second displacement is less than or equal to the first displacement.

### BRIEF DESCRIPTION OF THE DRAWINGS

FIG. 1 is a block diagram of an example attachment tool including a system for controlling a motor based on a flow rate of hydraulic fluid to the motor, in accordance with some implementations.

FIG. 2 is an example illustration of an electronic controller included in the system of FIG. 1, in accordance with some implementations.

FIG. 3 is a flowchart of an example method for determining a relationship between displacement of a motor and speed of the motor, in accordance with some implementations.

FIG. 4A and FIG. 4B is an example graphical illustration of the method of FIG. 3, in accordance with some implementations.

FIG. 5 is a flowchart of an example method for controlling a motor based on a flow rate of hydraulic fluid to the motor, in accordance with some implementations.

FIG. 6 is an example graphical illustration of a desired speed of a motor when the motor is loaded or unloaded, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

In this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

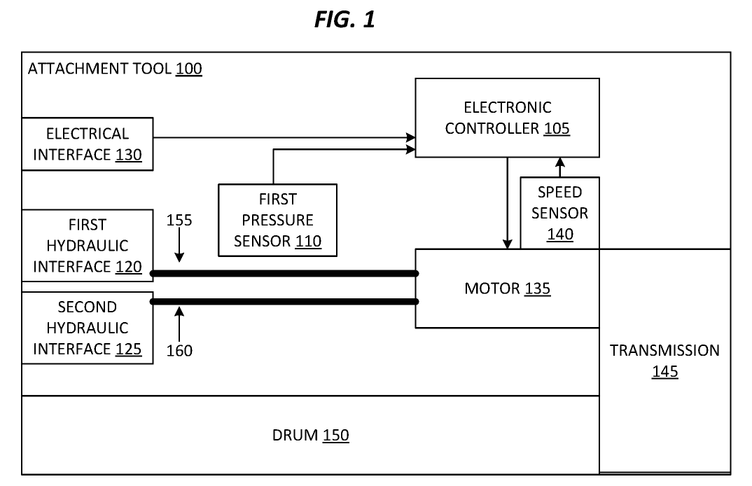

FIG. 1 illustrates an example attachment tool 100 including a system for controlling a motor based on a flow rate of hydraulic fluid to the motor, in accordance with some implementations. In the example illustrated in FIG. 1, the attachment tool 100 includes an electronic controller 105, a first pressure sensor 110, a first hydraulic interface 120, a second hydraulic interface 125, an electrical interface 130, a motor 135, a speed sensor 140, a transmission 145, and a drum 150.

The attachment tool 100 may be configured to be mechanically coupled to a carrier (for example, a skid steer, a backhoe, or the like) (not illustrated). In some implementations, the attachment tool 100 is also electrically and hydraulically coupled to the carrier. For example, the electronic controller 105 may receive electrical power from the carrier via the electrical interface 130. The electronic controller 105 may also connect to ground via the carrier. The motor 135 may receive hydraulic fluid from the carrier via the first hydraulic interface 120 and send hydraulic fluid to the carrier via the second hydraulic interface 125. In some implementations, hydraulic fluid is transmitted from the first hydraulic interface 120 to the motor 135 via a first hydraulic line 155 and hydraulic fluid may be transmitted to the second hydraulic interface 125 from the motor 135 via a second hydraulic line 160. In some implementations, a pressure of the hydraulic fluid traveling through the first hydraulic line 155 is measured by the first pressure sensor 110.

In some implementations, the hydraulic fluid from the carrier causes a shaft of the motor 135 to rotate. The rotation of the motor shaft is transferred via the transmission 145 (for example, via one or more gears and/belts included in the transmission 145) to the drum 150. As the drum 150 rotates, it performs cutting operations, chopping operations, mulching operations, a combination of the foregoing, or the like. The speed sensor 140 is configured to measure the rotational speed of the motor 135 (for example, the rotational speed of the rotor). The motor 135 may be one of a plurality of types of variable motor. In some implementations, a displacement of the motor 135 is adjustable between a minimum displacement and a maximum displacement. When the displacement of the motor 135 is set to the minimum displacement, the speed of the motor 135 is maximized but the torque of the motor 135 is decreased. When the displacement of the motor 135 is set to the maximum displacement, the speed of the motor 135 is decreased but the torque of the motor 135 is maximized. In some implementations, an electronic processor 200 (described below) controls the displacement of the motor 135 by increasing and decreasing current through a solenoid via pulse width modulation (PWM). For example, increasing the solenoid current may decrease the displacement of the motor 135. In one example, increasing and decreasing current through a solenoid changes a position of a control valve included in the motor 135. Changing the position of the control valve directs oil to the sides of a control piston of the motor 135 and causes the control piston to move, movement of the control piston, in turn, causes a swashplate of the motor 135 to move and the position or displacement of one or more pistons that ride on the swashplate to change.

In some implementations, one or more of the components of the attachment tool 100 are electrically and/or communicatively coupled to each other via direct or indirect wired or wireless connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, one or more of the components of the attachment tool 100 are communicatively coupled using suitable wireless modalities (for example, Bluetooth™ or near field communication connections).

In one example, the electronic controller 105 may be electrically connected to the electrical interface 130 via a wire or a cable. In some implementations, the first pressure sensor 110 and the speed sensor 140 are electrically and communicatively coupled to the electronic controller 105. In some implementations, the electronic controller 105 is electrically and communicatively coupled to the motor 135. While some components included in the attachment tool 100 are illustrated in FIG. 1 as communicating in a single direction, in some implementations, connections that are illustrated in FIG, 1 as unidirectional may be bidirectional. For example, while the speed sensor 140 is illustrated in FIG. 1 as transmitting signals and information to the electronic controller 105 but not receiving signals and information from the electronic controller 105, the speed sensor 140 may send signals and information to and receive signals and information from the electronic controller 105.

In some implementations, the electronic controller 105 may be configured to send information to a carrier that the attachment tool 100 is attached to. For example, the electronic controller 105 (more specifically, the electronic processor 200 included in the electronic controller 105), may send data such as speed of the motor 135, pressure of hydraulic fluid in the motor 135, or the like to the carrier. The carrier may, based on the data received from the electronic controller 105, display information or alerts via a user interface.

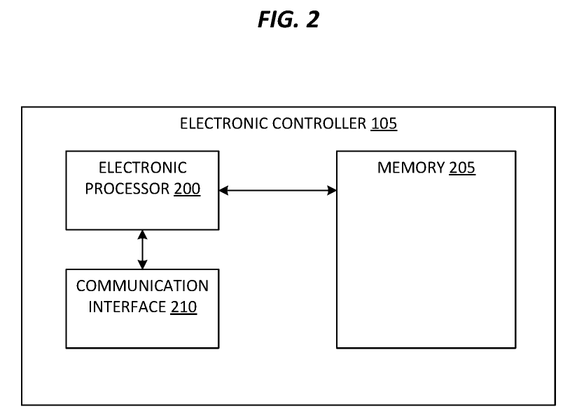

FIG. 2 provides an illustrative example of the components of the electronic controller 105. In the example illustrated in FIG. 2, the electronic controller 105 includes an electronic processor 200 (for example, a microprocessor, application specific integrated circuit, etc.), a memory 205, and a communication interface 210. The memory 205 may be made up of one or more non-transitory computer-readable media. The memory 205 can include combinations of different types of memory, such as read-only memory (“ROM”), random access memory (“RAM”), electrically erasable programmable read-only memory (“EEPROM”), flash memory, or other suitable memory devices. The electronic processor 200 is coupled to the memory 205 and the communication interface 210. The electronic processor 200 sends and receives information (for example, from the memory 205 and/or the communication interface 210) and processes the information by executing one or more software instructions or modules, capable of being stored in the memory 205, or another non-transitory computer readable medium. The software can include firmware, one or more applications, program data, filters, rules, one or more program modules, and other executable instructions. The electronic processor 200 is configured to retrieve from the memory 205 and execute, among other things, software for performing methods as described herein. The communication interface 210 transmits and receives information from devices external to the electronic controller 105 (for example, the speed sensor 140, the first pressure sensor 110, and the motor 135). In some implementations, the communication interface 210 includes a transceiver and the electronic processor 200 may transmit data regarding operation of the attachment tool 100 (for example speed data, pressure data, or the like) to one or more remote electronic devices (for example, servers).

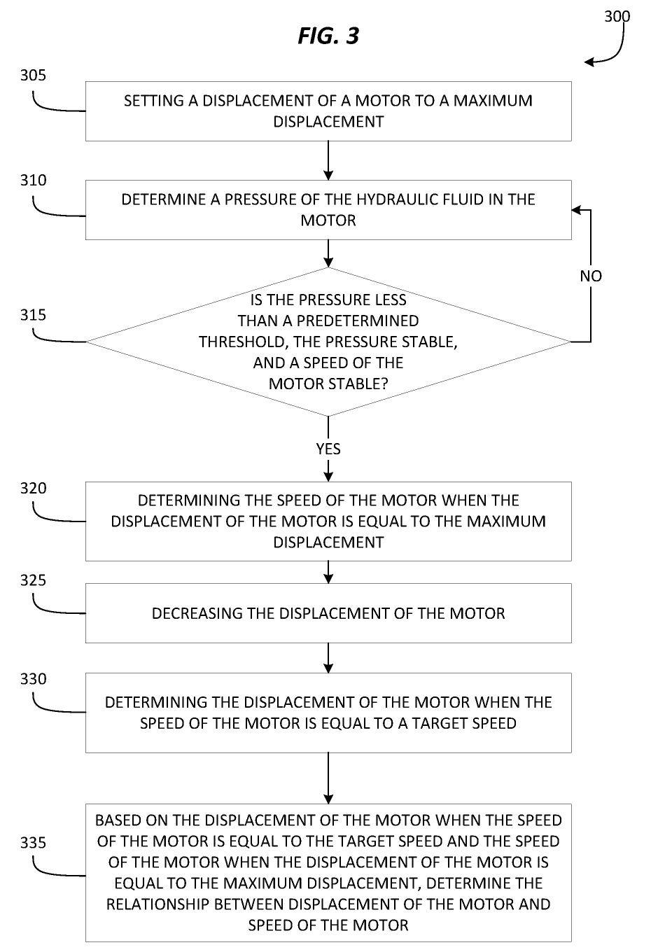

FIG. 3 illustrates a flowchart of an example method 300 for determining a relationship between displacement of a motor and speed of the motor. As described above, the relationship between displacement of the motor and speed of the motor is dependent upon the flow rate of hydraulic fluid from the carrier to the attachment tool 100. In some implementations, the attachment tool 100 may include a flow rate sensor and, instead of performing the method 300, the electronic processor 200 may determine the relationship between displacement of the motor and speed of the motor based on data received from the flow rate sensor.

In some implementations, the electronic processor 200 is configured to perform the method 300 when the attachment tool 100 is powered on and hydraulic fluid begins to flow from the carrier to the motor 135 via the first hydraulic line 155. In some implementations, the method 300 begins at step 305 when the electronic processor 200 sets a displacement of a motor (for example, the motor 135) to a maximum displacement.

In some implementations, at step 310, the electronic processor 200 determines a pressure of the hydraulic fluid in the motor 135. In some implementations, the electronic processor 200 is configured to determine the pressure of hydraulic fluid in the motor 135 based on the pressure measured by the first pressure sensor 110.

In some implementations, at step 315, the electronic processor 200 determines whether the pressure is less than a predetermined threshold, the pressure has stabilized, and the speed of the motor 135 has stabilized. In some implementations, the electronic processor 200 determines that the pressure has stabilized when pressure variation remains within a threshold range for a predetermined amount of time. In some implementations, the electronic processor 200 determines that the speed of the motor 135 has stabilized when speed variation remains within a threshold range for a predetermined amount of time. When the pressure is less than the predetermined threshold, the pressure has stabilized, and the speed of the motor 135 has stabilized, the electronic processor 200 proceeds to perform the functionality described in relation to step 320. When the pressure is not less than the predetermined threshold, the pressure has not stabilized, or the speed of the motor 135 has not stabilized, the motor 135 remains at maximum displacement and the electronic processor 200 periodically redetermines whether the pressure is less than a predetermined threshold, the pressure has stabilized, and the speed of the motor 135 has stabilized until a timeout threshold is reached. If a timeout threshold is reached and the pressure is not less than a predetermined threshold, the pressure has not stabilized, or the speed of the motor 135 has not stabilized, the electronic processor 200 ceases to perform the method 300. The electronic processor 200 may perform the method 300 again after the attachment tool 100 is restarted (powered off and then powered on).

In some implementations, at step 320, the electronic processor 200 determines, using the speed sensor 140, a speed of the motor 135 when the displacement of the motor 135 is equal to the maximum displacement. The electronic processor 200 may then, at step 325, decrease the displacement of the motor 135 from the maximum displacement. As the displacement of the motor 135 decreases, the electronic processor 200 monitors the speed of the motor 135, based on signals and information received from the speed sensor 140. When the speed of the motor 135 is equal to the target speed, at block 330, the electronic processor 200 determines the displacement of the motor 135. In some implementations, if, when the electronic processor 200 is performing the functionality described in relation to steps 320-330, the electronic processor 200 determines that the pressure of the hydraulic fluid in the motor 135 exceeds the predetermined threshold described above in relation to step 315, the electronic processor 200 returns to step 305 and re-executes the method 300.

In some implementations, at step 335, based on the displacement of the motor 135 when the speed of the motor 135 is equal to the target speed and the speed of the motor 135 when the displacement of the motor 135 is equal to the maximum displacement, the electronic processor 200 determines the relationship between displacement of the motor 135 and speed of the motor 135. For example, given a coordinate space where a first axis represents displacement of the motor 135 and a second axis represents speed of the motor 135, a first point representing the displacement of the motor 135 when the speed of the motor 135 is equal to the target speed and a second point representing the speed of the motor 135 when the displacement of the motor 135 is equal to the maximum displacement, the electronic processor 200 determines the linear relationship between motor speed and motor displacement based on the first and second points.

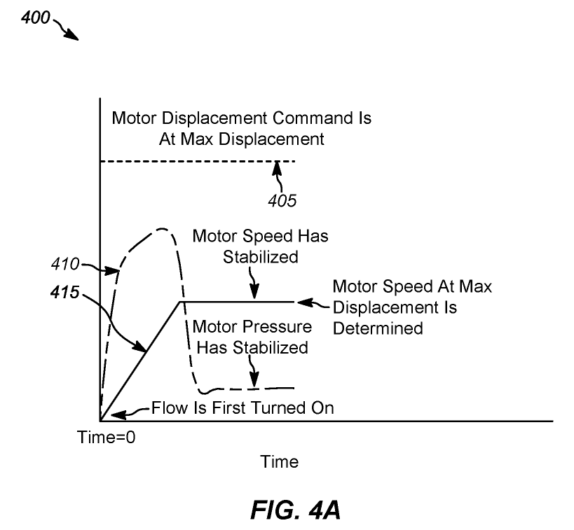

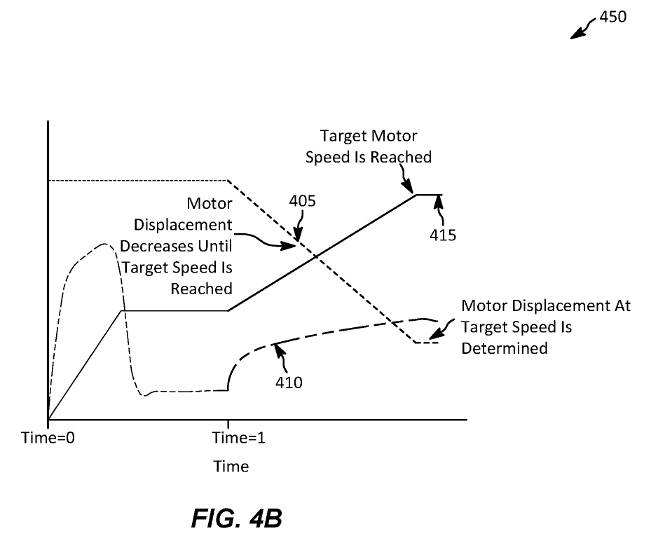

FIG. 4A and FIG. 4B provide an example graphical illustration of the method 300. The graph 400 illustrated in FIG. 4A highlights steps 305-320 of the method 300. The graph 450 illustrated in FIG. 4B highlights steps 325-330 of the method 300. In the graphs 400 and 450, the x-axis represents time and the y-axis represents displacement, pressure, and speed. In the graphs 400 and 450, the dashed line 405 represents the displacement of the motor 135, the thin solid line 410 represents the pressure of the hydraulic fluid in the motor 135, and the thick solid line 415 represents the speed of the motor 135.

In the graph 400, at time = 0 the attachment tool 100 is powered on and hydraulic fluid begins to flow from the carrier to the attachment tool 100. At time = 0, the displacement of the motor 135 is maximum displacement. As can be seen in the graph 400, after the attachment tool 100 is powered on, the pressure of the hydraulic fluid in the motor 135 spikes and then stabilizes. Around the same time that the pressure of the hydraulic fluid in the motor 135 stabilizes, the speed of the motor 135 stabilizes or plateaus. When the displacement of the motor 135 is at maximum displacement and the pressure of the hydraulic fluid in the motor 135 (and the speed of the motor 135) is stable, the electronic processor 200 determines the speed of the motor 135.

In the graph 450, at time = 1, the electronic processor 200 decreases the displacement of the motor 135. As can be seen from the graph 450, as the displacement of the motor 135 is decreased, the speed of the motor 135 increases. When the speed of the motor 135 is equal to a target speed, the electronic processor 200 stops decreasing the displacement of the motor 135 and determines the displacement of the motor 135.

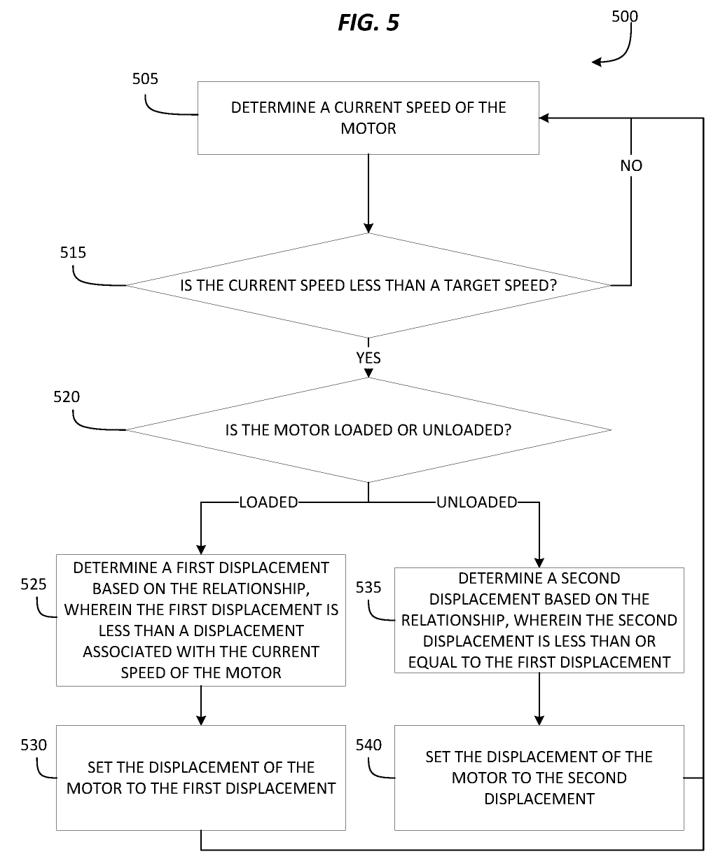

FIG. 5 illustrates a flowchart of an example method 500 for controlling a motor based on a flow rate of hydraulic fluid to the motor (for example, the motor 135). In some implementations, the method 500 begins at step 505 when the electronic processor 200 determines a current speed of the motor 135.

In some implementations, at step 515, the electronic processor 200 determines whether the current speed of the motor 135 is less than a target speed. The target speed referred to in step 515 may be the same as the target speed described in relation to the method 300. When the current speed of the motor 135 is greater than or equal to the target speed, the method 300 returns to step 505 and the electronic processor 200 may redetermine the current speed of the motor 135. When the current speed of the motor 135 is less than the target speed, the electronic processor 200, at step 520, determines whether the motor 135 is loaded or unloaded. In some implementations, the electronic processor 200 determines that the motor 135 is loaded when a speed of the motor 135 decreases at least a predetermined amount over a predetermined period of time and determines that the motor 135 is unloaded when the speed of the motor 135 does not decrease at least the predetermined amount over the predetermined period of time. In some implementations, the electronic processor 200 determines that the motor 135 is loaded when the pressure of the hydraulic fluid in the motor 135 exceeds a predetermined threshold (in some implementations, a predetermined threshold that is greater that the predetermined threshold referred to in relation to step 315).

In some implementations, when the electronic processor 200 determines that the motor 135 is loaded, at step 525, the electronic processor 200 determines a first displacement based on the relationship between motor displacement and motor speed determined at step 335 of the method 300. At step 530, the electronic processor 200 sets the displacement of the motor 135 to the first displacement. In some implementations, the first displacement is less than a displacement associated with the current speed of the motor 135. The first displacement may be associated with the target speed or a speed that is a first predetermined percentage greater than the current speed. For example, the electronic processor 200 may determine the first displacement by determining a desired speed that is a first predetermined percentage (for example, 20 percent) greater than the current speed of the motor 135 determined at step 505. If the determined desired speed is greater than the target speed, then the electronic processor 200 determines the desired speed to be the target speed. In other words, in some implementations, the desired speed is not greater than the target speed. The electronic processor 200 may determine, based on the relationship between motor displacement and motor speed determined at step 335 of the method 300, the first displacement of the motor 135 based on the desired speed. Because the desired speed is greater than the current speed, the first displacement associated with the desired speed is less than the displacement associated with the current speed.

In some implementations, when the electronic processor 200 determines that the motor 135 is unloaded, at step 535, the electronic processor 200 determines a second displacement based on the relationship between motor displacement and motor speed determined at step 335 of the method 300. At step 540, the electronic processor 200 sets the displacement of the motor 135 to the second displacement. In some implementations, the second displacement is less than the first displacement. The second displacement may be associated with the target speed or a speed that is second predetermined percentage greater than the current speed and the second predetermined percentage may be greater than the first predetermined percentage.

For example, the electronic processor 200 may determine the second displacement by determining a desired speed that is a second predetermined percentage (for example, 30 percent) greater than the current speed of the motor 135 determined at step 505. If the determined desired speed is greater than the target speed, then the electronic processor 200 determines the desired speed to the target speed. In other words, in some implementations, while the desired speed is higher than the current speed, the desired speed is not greater than the target speed. The electronic processor 200 may determine, based on the relationship between motor displacement and motor speed determined at step 335 of the method 300, the second displacement of the motor 135 associated with the desired speed. Because the desired speed is greater than the current speed, the second displacement associated with the desired speed is less than the displacement associated with the associated with the current speed. Because the second predetermined percentage is greater than the first predetermined percentage, the second displacement may be less than the first displacement. However, because the desired speed is not greater than the target speed, in some situations, the second displacement may be equal to the first displacement.

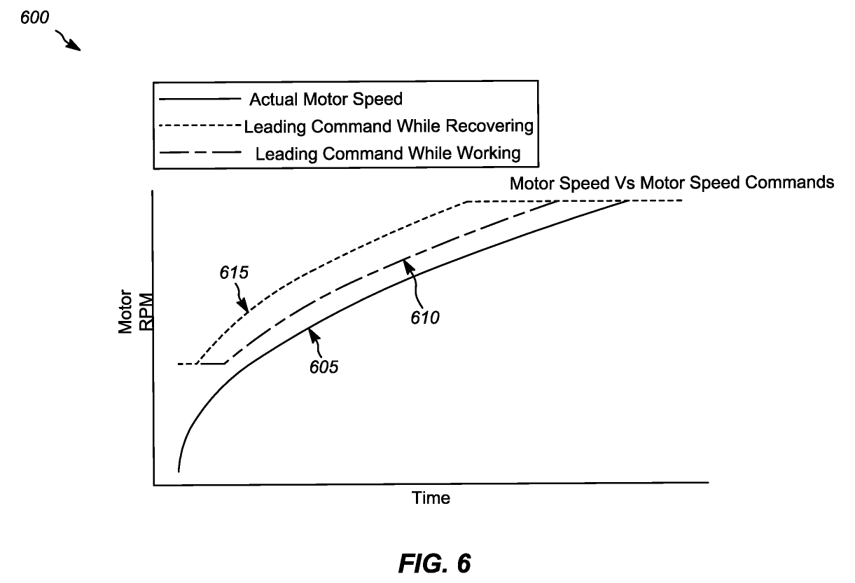

FIG. 6 provides an example graphical illustration of the desired speed of the motor 135 when the motor 135 is loaded or unloaded. In FIG. 6 the x-axis of the graph 600 represents time and the y-axis of the graph 600 represents the speed of the motor 135. The line 605 represents the current or actual speed of the motor 135. The line 610 represents the desired speed of the motor 135 when the motor 135 is loaded (a leading command while the motor 135 is working). The line 615 represents the desired speed of the motor 135 when the motor 135 is unloaded (the leading command while the motor 135 is recovering). As can be seen in FIG. 6, when the motor 135 is unloaded the electronic processor 200 aggressively attempts to increase the speed of the motor 135 by determining a faster desired speed. In comparison, when the motor 135 is loaded, the electronic processor 200 attempts to increase the speed of the motor 135 less aggressively (and produce a greater amount of torque) by determining a slower desired speed.

In some implementations, the electronic processor 200 is configured to reperform the functionality described in relation to the method 500 until the attachment tool 100 is powered off. In some implementations, the electronic processor 200 determines that the attachment tool 100 is powered off when the pressure of the hydraulic fluid in the motor 135 drops below a predetermined threshold.

Thus, examples, aspects, and features herein provide, among other things, systems and methods for controlling a motor based on a flow rate of hydraulic fluid to the motor.

What is claimed is:

1. A system for controlling a motor based on a flow rate of hydraulic fluid to the motor, the system comprising:
an electronic processor, the electronic processor configured to:
determine a current speed of the motor; and
when the current speed is less than a target speed,
determine whether the motor is loaded or unloaded;
when the motor is loaded,
determine a first displacement based on a relationship between displacement of the motor and speed of the motor, wherein the first displacement is less than a displacement associated with the current speed of the motor; and
set the displacement of the motor to the first displacement; and
when the motor is unloaded,
determine a second displacement based on the relationship, wherein the second displacement is less than or equal to the first displacement; and
set the displacement of the motor to a second displacement.

2. The system of claim 1, wherein the system is included in an attachment tool, wherein the attachment tool is configured to attach to a carrier.

3. The system of claim 2, wherein the attachment tool is configured to receive electrical power and hydraulic fluid from the carrier.

4. The system of claim 1, wherein the electronic processor is further configured to:
based on the displacement of the motor when a speed of the motor is equal to a target speed and a speed of the motor when the displacement of the motor is equal to a maximum displacement, determine the relationship between displacement of the motor and speed of the motor.

5. The system of claim 4, the system further comprising a pressure sensor and the electronic processor further configured to:
determine, using the pressure sensor, a pressure of hydraulic fluid in the motor; and
when the pressure is less than a predetermined threshold, the pressure has stabilized, and the speed of the motor has stabilized, determine the relationship between displacement of the motor and speed of the motor.

6. The system of claim 4, wherein the electronic processor is configured to determine the relationship between displacement of the motor and speed of the motor by:
setting the displacement of the motor to the maximum displacement;
determining the speed of the motor when the displacement of the motor is equal to the maximum displacement;
decreasing the displacement of the motor; and
determining the displacement of the motor when the speed of the motor is equal to the target speed.

7. The system of claim 1, wherein the electronic processor is configured to determine whether the motor is loaded or unloaded by:
determining that the motor is loaded when a speed of the motor decreases at least a predetermined amount over a predetermined period of time.

8. The system of claim 1, wherein the electronic processor is configured to determine whether the motor is loaded or unloaded by:
determining that the motor is loaded when a pressure of hydraulic fluid in the motor is greater than a predetermined threshold.

9. The system of claim 1, wherein the first displacement is associated with the target speed or a speed that is first predetermined percentage greater than the current speed and the second displacement is associated with the target speed or a speed that is second predetermined percentage greater than the current speed, wherein the second predetermined percentage is greater than the first predetermined percentage.

10. A method for controlling a motor based on a flow rate of hydraulic fluid to the motor, the method comprising:
determining a current speed of the motor; and
when the current speed is less than a target speed,
determining whether the motor is loaded or unloaded;
when the motor is loaded,
determining a first displacement based on a relationship between displacement of the motor and speed of the motor, wherein the first displacement is less than a displacement associated with the current speed of the motor; and
setting the displacement of the motor to the first displacement; and
when the motor is unloaded,
determining a second displacement based on the relationship, wherein the second displacement is less than or equal to the first displacement; and
setting the displacement of the motor to a second displacement.

11. The method of claim 10, wherein the motor is included in an attachment tool, wherein the attachment tool is configured to attach to a carrier.

12. The method of claim 11, wherein the attachment tool is configured to receive electrical power and hydraulic fluid from the carrier.

13. The method of claim 10, the method further comprising:
based on the displacement of the motor when a speed of the motor is equal to a target speed and a speed of the motor when the displacement of the motor is equal to a maximum displacement, determining the relationship between displacement of the motor and speed of the motor.

14. The method of claim 13, the method further comprising:
determining, using a pressure sensor, a pressure of hydraulic fluid in the motor; and
when the pressure is less than a predetermined threshold, the pressure has stabilized, and the speed of the motor has stabilized, determining the relationship between displacement of the motor and speed of the motor.

15. The method of claim 13, wherein determining the relationship between displacement of the motor and speed of the motor includes:
setting the displacement of the motor to the maximum displacement;
determining the speed of the motor when the displacement of the motor is equal to the maximum displacement;
decreasing the displacement of the motor; and
determining the displacement of the motor when the speed of the motor is equal to the target speed.

16. The method of claim 10, wherein determining whether the motor is loaded or unloaded includes:
determining that the motor is loaded when a speed of the motor decreases at least a predetermined amount over a predetermined period of time.

17. The method of claim 10, wherein determining whether the motor is loaded or unloaded includes:
determining that the motor is loaded when a pressure of hydraulic fluid in the motor is greater than a predetermined threshold.

18. The method of claim 10, wherein the first displacement is associated with the target speed or a speed that is first predetermined percentage greater than the current speed and the second displacement is associated with the target speed or a speed that is second predetermined percentage greater than the current speed, wherein the second predetermined percentage is greater than the first predetermined percentage.
